(19) United States
(12) Patent Application Publication
(10) Pub. No.: US 2020/0148286 A1
(43) Pub. Date: May 14, 2020

(54) TWO-POINT CAB SUSPENSION SYSTEM

(71) Applicant: AGCO Corporation, Duluth, GA (US)

(72) Inventors: Daniel J. Soldan, Hesston, KS (US); Ario Kordestani, Jackson, MN (US); Jarred M. Jennings, Hesston, KS (US)

(21) Appl. No.: 16/610,381

(22) PCT Filed: Apr. 12, 2018
(86) PCT No.: PCT/IB2018/000367

§ 371 Date: Nov. 1, 2019

Related U.S. Application Data
(60) Provisional application No. 62/492,381, filed on May 1, 2017.

(51) Int. Cl. B62D 33/06; B60G 15/06

(52) U.S. Cl. CPC B62D 33/0608; B60G 15/067; B60G 15/063; B60G 2204/162; B60G 2204/41; B60G 2204/1242; B60G 2300/08; B60G 2202/152; B60G 2204/15

(57) ABSTRACT

In one embodiment, a suspension system for a vehicle cab, the suspension system comprising: a structural assembly; a cab mounted to the structural assembly; a front axle coupled to the structural assembly; plural suspension units arranged forward of the axle and disposed between the cab and the structural assembly; and plural isolation mounts arranged rearward of the axle and disposed between the cab and the structural assembly.

### TECHNICAL FIELD

The present disclosure is generally related to vehicle cab suspension systems.

### BACKGROUND

Current two (2)-point cab suspension system performance is less than desired. In vehicles such as a self-propelled windrower, for instance, the stiff, rubber isolation mounts are at the front of the cab and positioned over a front axle of the windrower traction unit. Vertical movements of either, or both sides, of the axle are directly transmitted to the isolation mounts with little suspension benefit. Suspension units (e.g., low frequency suspension units, including coil or air spring over shock absorber) are positioned at the rear corners of the cab, reward of the front axle, owing to the fact that windrowers have been borne from tractor designs and the observation that the operator, for whom which ride comfort is desired, sits closest to the suspension units.

### BRIEF DESCRIPTION OF THE DRAWINGS

Many aspects of certain embodiments of 2-point cab suspension systems and methods can be better understood with reference to the following drawings. The components in the drawings are not necessarily to scale, emphasis instead being placed upon clearly illustrating the principles of the present systems and methods. Moreover, in the drawings, like reference numerals designate corresponding parts throughout the several views.

FIG. 1 is a schematic diagram that illustrates, in front perspective view, an example vehicle in which an embodiment of a 2-point cab suspension system may be implemented.

FIG. 2 is a schematic diagram that conceptually illustrates, in fragmentary, plan view, the relative positioning of select components for an embodiment of a 2-point cab suspension system.

FIG. 3A is a schematic diagram that illustrates, in fragmentary, rear-perspective view, select components of an embodiment of a 2-point cab suspension system.

FIG. 3B is a schematic diagram that illustrates, in fragmentary, front-perspective view, select components of an embodiment of a 2-point cab suspension system.

FIG. 3C is a schematic diagram that illustrates, in fragmentary, front bottom perspective view, select components of an embodiment of a 2-point cab suspension system.

FIG. 4 is a flow diagram that illustrates an embodiment of an example 2-point cab suspension method.

### DESCRIPTION OF EXAMPLE EMBODIMENTS

### Overview

In one embodiment, a suspension system for a vehicle cab, the suspension system comprising: a structural assembly; a cab mounted to the structural assembly; a front axle coupled to the structural assembly; plural suspension units arranged forward of the axle and disposed between the cab and the structural assembly; and plural isolation mounts arranged rearward of the axle and disposed between the cab and the structural assembly.

### DETAILED DESCRIPTION

Certain embodiments of a two-point (herein, also 2-point) cab suspension system and method are disclosed that arrange suspension units between the cab and the chassis forward of the axle and isolation mounts between the cab and the chassis rearward of the axle. Through this arrangement, excitation forces from the axle are dampened in view of the proximity of the primarily low frequency dampening attributes of the suspension units, leading to improved comfort for an operator in the cab when compared to conventional 2-point cab suspension arrangements. The embodiments described below are in the context of a vehicle embodied as an agricultural vehicle, and in particular, a self-propelled windrower, with the understanding that cab suspension systems for other vehicles may be used in some embodiments.

Digressing briefly, windrower cab suspension systems are generally an outgrowth of tractors (e.g., row crop tractors). Row crop tractors with 2-point cab suspension systems generally have rubber mounts arranged toward the front of the cab and suspension units arranged toward the rear of the cab. Windrowers, due to their unique drive arrangement, are somewhat like a row tractor but flipped around. Legacy designs for the windrower essentially have applied the row tractor cab suspension systems to the windrower cab suspension systems, with the fore and aft arrangement of rubber mounts and suspension units between the cab and the chassis, despite the fact that row crop tractors also have an axle proximal to where the operator sits. One school of thought preserving that arrangement over the years is the observation that the operator sits closer to the rearward suspension units than the rubber mounts in the windrower, and hence vibrations (low frequency vibrations) resulting from the windrower navigating over the soil surface of a field and transmitted through the axle to the cab are best handled by arranging the suspension units in proximity to where the operator sits in the cab. In contrast, certain embodiments of 2-point cab suspension systems improve ride comfort by flipping the arrangement of conventional row tractors (and windrowers), arranging the suspension units toward the front, closer to the axle, which more effectively counters the forces emanating from the axle by virtue of windrower travel across the field.

Having summarized certain features of a 2-point cab suspension system of the present disclosure, reference will now be made in detail to the description of a 2-point cab suspension system as illustrated in the drawings. While an example 2-point cab suspension system will be described in connection with these drawings, there is no intent to limit it to the embodiment or embodiments disclosed herein. For instance, as indicated above, certain embodiments of a 2-point cab suspension system are described in the context of its use in an agricultural vehicle, and in particular, a self-propelled windrower. However, in some embodiments, the 2-point cab suspension system may be used in other agricultural vehicles, or in vehicles used in other industries, including mining, construction, military, government, etc. Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the vehicle (e.g., windrower) looking forwardly. The terms fore and aft and transverse, as used herein, are referenced to the longitudinal centerline of the windrower chassis as the windrower travels in a forward direction.

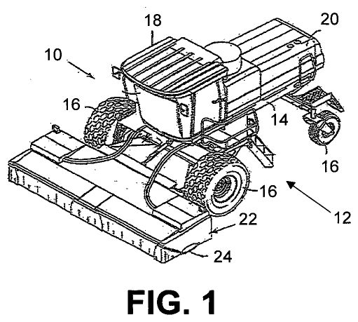

Referring now to FIG. 1, shown is an example vehicle, and in particular, a self-propelled windrower 10 in which an embodiment of a 2-point cab suspension system 12 may be implemented. One having ordinary skill in the art should appreciate in the context of the present disclosure that the example windrower 10 depicted in FIG. 1 is of one type of self-propelled design, and that other windrower designs or other types of vehicles may be used and hence are contemplated to be within the scope of the disclosure. The windrower 10 is operable to mow and collect standing crop in the field, condition the cut material (e.g., using one or more pairs of conditioner rolls) to improve its drying characteristics, and then return the conditioned material to the field in a windrow or swath. The windrower 10 may include a chassis or frame 14 supported by wheels 16 (although tracks may be used in some embodiments, or other configurations in the number and/or arrangement of wheels may be used in some embodiments) for movement across a field to be harvested. The chassis 14 supports a cab 18, within which an operator may control certain operations of the windrower 10, and a rearwardly spaced compartment 20 housing a power source (not shown) such as an internal combustion engine. The chassis 14 also supports a ground drive system that, in one embodiment, when powered by the engine, causes differential rotation of the wheels (e.g., increasing the speed of one wheel while decreasing the speed of the opposite wheel) according to a dual path steering mechanism as is known in the art. In some embodiments, other mechanisms for enabling navigation and/or traversal of the field may be used.

A coupled working implement, depicted in FIG. 1 as a harvesting header 22, is supported on the front of the chassis 14 in a manner understood by those skilled in the art. The header 22 may be configured as a modular unit and consequently may be disconnected for removal from the chassis 14. As is also known in the art, the header 22 has a laterally extending crop cutting assembly 24 in the form of a low profile, rotary style cutter bed located adjacent the front of the header 22 for severing crop from the ground as the windrower 10 navigates across a surface in the field. However, one skilled in the art will understand that other types of crop cutting assemblies 24, such as sickle style cutter beds, may also be used in some embodiments.

The windrower 10 also includes the 2-point cab suspension system 12, which includes plural suspension units arranged forward of the front axle of the windrower 10 and plural isolation mounts (e.g., rubber mounts) that are arranged rearward of the front axle of the windrower 10, all disposed between the cab 18 and the chassis 14, to improve ride comfort for the operator, as explained further below. Note that for air spring-based suspension units, additional components may include a source of air (e.g., compressor) as is known to those having ordinary skill in the art.

During a harvesting operation, the windrower 10 moves forward through the field with the header 22 lowered to a working height. Ground conditions (e.g., moist ground, soft ground, etc.), including ground surface topology (e.g., bumpy terrain, smooth terrain, obstacles, etc.), encountered by the tires, may impose low frequency vibrations on the cab 18 (and also experienced by an operator) during the ride. The 2-point cab suspension system 12 ensures a comfortable ride for the operator despite the condition of the terrain the windrower 10 encounters.

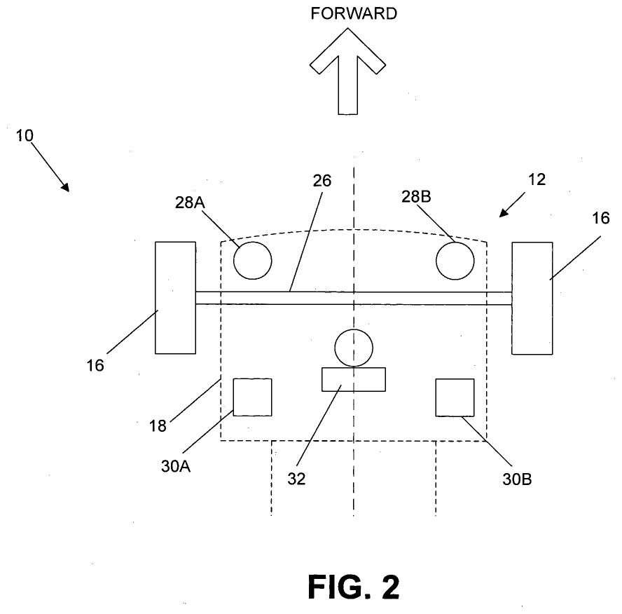

Attention is now directed to FIG. 2, which conceptually illustrates an example of the relative positioning of select components for an embodiment of the 2-point cab suspension system 12. Certain known components, which would be readily apparent to one having ordinary skill in the art, are omitted from FIG. 2 to avoid obfuscating relevant components of the 2-point cab suspension system 12. In some embodiments, additional components, or fewer components, may constitute the 2-point cab suspension system 12. An arrow at the top of FIG. 2 shows the forward direction for the windrower 10, with a longitudinal centerline running through the windrower 10, and the rear portion of the windrower 10 omitted for brevity and clarity. In one embodiment, the 2-point cab suspension system 12 comprises the cab 18, which is mounted to the chassis 14 (FIG. 1), a front axle 26 to which the wheels 16 (which has mounted thereon tires) are operatively coupled and which is also coupled to the chassis 14 in known manner, plural suspension units 28 (e.g., a pair shown, including suspension units 28A, 28B) arranged between the forward end of the cab 18 and the chassis 14 and arranged forward of the axle 26, and plural isolation mounts 30 (e.g., a pair shown, including isolation mounts 30A, 30B), which are also arranged between the rearward end of the cab 18 and the chassis 14 and arranged rearward of the axle 26 and in-line longitudinally with the respective suspension units 28. In one embodiment, an operator 32 sits centrally (laterally between the sides of the cab 18) aligned with the longitudinal axis, and is positioned closer to the isolation mounts 30 than the suspension units 28, though the suspension units 28 are closer to the front axle 26 than the isolation mounts 30. The source of low frequency vibrations is the tires 16 of the windrower 10 traversing over the terrain. These vibrations are transmitted through the axle 26, the chassis 14 (FIG. 1), etc. into the cab 18. Thus, the transmitted vibrations, particularly those transmitted through the axle 26, are dampened primarily by the suspension units 28.

The isolation mounts 30 may be configured as known rubber mounts, which have a deformation under cab load that is measured in millimeters. As is known, the isolation mounts 30 are applicable for dampening high-frequency (e.g., greater than approximately 10-12 Hz) vibrations, such as those small displacement disturbances that are generated by the machine (windrower) or machine components (e.g., hydraulic pumps, the engine, etc.).

The suspension units 28 are applicable for dampening primarily low-frequency vibrations, such as those generated by virtue of the windrower 10 traversing a field. Note that the low natural frequency of the suspension units 28 means the suspension units 28 are capable of dampening high frequencies, though the physical needs of their design (e.g., holding up a heavy cab) also means they do transmit high frequency vibration through their structure. That is, the terrain causes the low frequency vibrations that emanate through the tires 16, chassis 14 (FIG. 1), axle 26, and the cab 18, where the vibrations are experienced by the operator in the cab. The load-induced travel of the suspension units 28, unlike isolation mounts, is measured in inches under cab load (e.g., total travel of approximately 2-3 inches). The suspension units 28 may be configured as one or any combination of an air spring or coil over shock absorber in an integrated or physically separate components, packages, or units that collectively function together to dampen forces transmitted from the axle 26 to the cab 18. The air spring may comprise integrated (or external in some embodiments) leveling valves that add or release air from the air springs, as is known.

In one′ embodiment, the suspension units 28 operate under passive control (e.g., not electronically or manually adjustable in the field). In some embodiments, the suspension units 28 may operate under active or semi-active control.

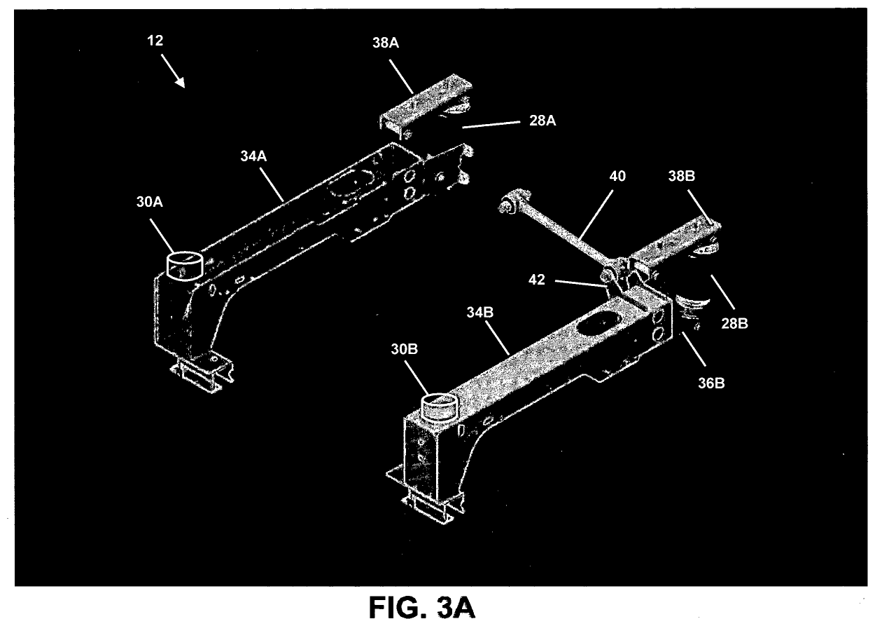

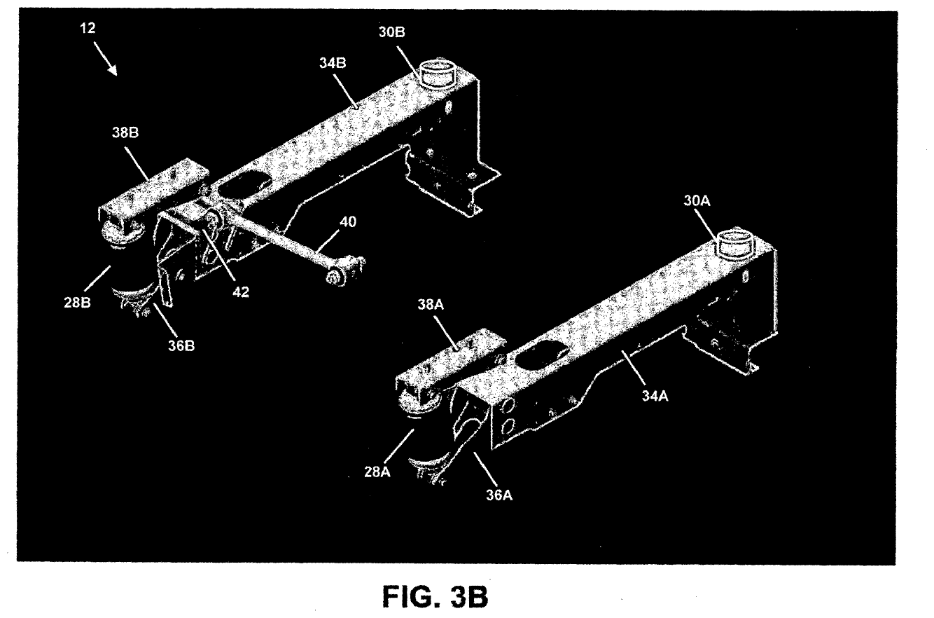

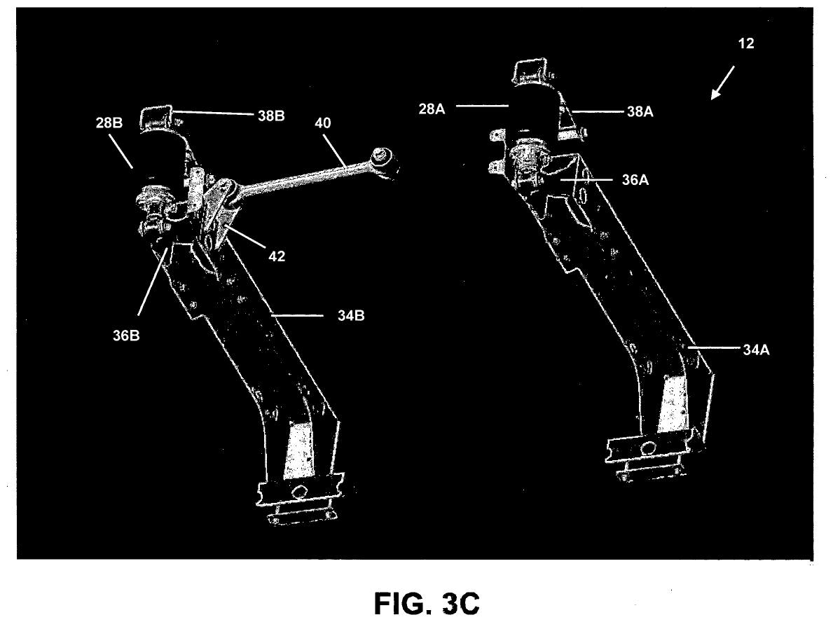

Attention is now directed to FIGS. 3A-3C, which illustrate various fragmentary views of select portions of the 2-point cab suspension system 12. In some embodiments, all of the components shown in FIGS. 3A-3C comprise an embodiment of the 2-point cab suspension system 12. In some embodiments, fewer or additional components than those shown in FIGS. 3A-3C make up certain embodiments of the 2-point cab suspension system 12. In one embodiment, the 2-point cab suspension system 12 comprises two separate, parallel frames 34A, 34B (collectively referred to as a sub-frame 34). The sub-frame 34 and the chassis or frame 14 of the windrower 10 (FIG. 1) are collectively referred to herein as a structural assembly. It should be appreciated by one having ordinary skill in the art that, though the sub-frame 34 is shown disposed between the cab 18 and the chassis 14, in some embodiments, the sub-frame 34 may be omitted (and hence both the front pair of suspension units 28 and the rear isolation mounts 30 may be attached directly to the chassis 14). In some embodiments, other variations in attachment connection between the cab 18 and the chassis 14 (e.g., using one or more sub-frames or changing the manner of attachment/affixing, whether by weld, bolts, tacks, etc. to the front suspension units 28, the isolation mounts 30, or the cab 18) are contemplated to be within the scope of the disclosure. Each of the front pair of suspension units 28 is respectively attached at one end (lower end) of the suspension unit 28 to a bracket 36 (e.g., 36A, 36B) extending forwardly from the sub-frame 34 (e.g., 34A, 34B), the bracket 36 affixed (attached and affixed used interchangeably herein) to the sub-frame 34 using known attachment mechanisms (e.g., weld, tack, bolted, etc.). The other end (upper end) of each of the front pair of suspension units 28 is coupled to the cab 18 (proximal the forward portion of the cab 18) via a respective mount bracket 38 (e.g., 38A, 38B).

In one embodiment, the mount bracket 38 is of a generally rectangular, U-shaped configuration, with the top surface of the mount bracket 38 affixed to a bottom surface (or intervening structure) of the cab 18, and at one end (forward end) of the front mount bracket 38, affixed (e.g., bolted) between the U-shaped walls of the front mount bracket 38 to a top mounting end (e.g., ring or trunnion mount) of the front suspension unit 28. Variations to the design of the front mount bracket 38 may be used to achieve a similar function, as would be appreciated by one having ordinary skill in the art in the context of the present disclosure.

Coupled to one of the sub-frames (sub-frame 34B), at a forward end proximal to the bracket 36, is a transverse member 40, which in one embodiment is configured as a Panhard rod. The transverse member 40 is pivotably attached to a mounting bracket 42. In one embodiment, the mounting bracket 42 may be configured as a trunnion affixed (e.g., welded, tacked, etc.) to the top and internal side surfaces of the sub-frame 34B. The transverse member 40 extends inwardly and transverse to the sub-frame 34B (and beneath a portion of the cab 18, extending to approximately the longitudinal midline of the cab 18). In some embodiments, the transverse member 40 may be coupled to the opposing sub-frame 34A instead. The pivotable movement of the transverse member 40 enables movement in an arc as the cab 18 moves up and down. The transverse member 40 is attached at the end opposite the mounting bracket 42 directly or indirectly via a structural member or frame (e.g., a U-shaped bracket attached to the underside of the cab 18) to the underside surface of the cab 18, approximately at the longitudinal midline of the cab 18. Though the isolation mounts 30 secure the back of the cab 18 to the sub-assembly, side-to-side movement at the front of the cab 18 is restrained by the transverse member 40.

It should be appreciated by one having ordinary skill in the art, in the context of the disclosure, that particular details of the assembly and/or construction of the 2-point cab suspension system 12 is illustrative of one embodiment, and that variations to the above description may be implemented to achieve a similar function as long as the relative arrangement of the suspension units 28 and the isolation mounts 30 is preserved.

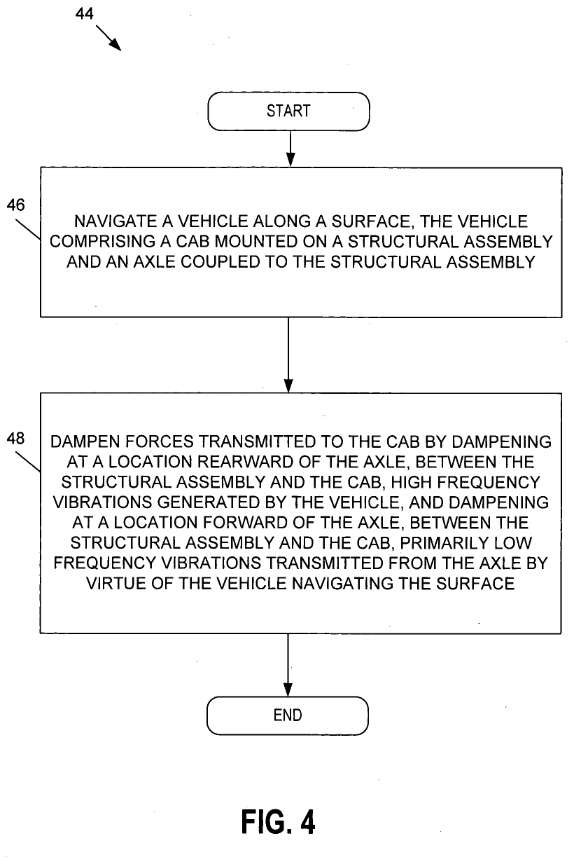

In view of the above description, it should be appreciated that one embodiment of a 2-point cab suspension method 44, depicted in FIG. 4, comprises navigating a vehicle along a surface, the vehicle comprising a cab mounted on a structural assembly and an axle coupled to the structural assembly (46); and dampening forces transmitted to the cab by dampening at a location rearward of the axle, between the structural assembly and the cab, high frequency vibrations generated by the vehicle, and dampening at a location forward of the axle, between the structural assembly and the cab, primarily low frequency vibrations transmitted from the axle by virtue of the vehicle navigating the surface (48).

Any process descriptions or blocks in flow diagrams should be understood as representing steps in a process, and alternate implementations are included within the scope of the embodiments with additional steps, as would be understood by those reasonably skilled in the art of the present disclosure.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although the systems and methods have been described with reference to the example embodiments illustrated in the attached drawing figures, it is noted that equivalents may be employed and substitutions made herein without departing from the scope of the disclosure as protected by the following claims.

At least the following is claimed:

1. A suspension system for a vehicle cab, the suspension system comprising:
a structural assembly;
a cab mounted to the structural assembly;
a front axle coupled to the structural assembly;
plural suspension units arranged forward of the axle and disposed between the cab and the structural assembly; and
plural isolation mounts arranged rearward of the axle and disposed between the cab and the structural assembly.

2. The suspension system of claim 1, wherein the plural suspension units each comprises a coil over shock absorber.

3. The suspension system of claim 1, wherein the plural suspension units each comprises an air spring over shock absorber.

4. The suspension system of claim 1, wherein the plural suspension units each comprises two separate components, wherein one of the components comprises either a coil or air spring and the other of the components comprises a shock absorber.

5. The suspension system of claim 1, wherein each of the plural isolation mounts is comprised of rubber.

6. The suspension system of claim 1, further comprising a transverse member coupled between the structural assembly and the cab.

7. The suspension system of claim 1, wherein the structural assembly comprises a vehicle frame and a sub-frame mounted to the vehicle frame.

8. The suspension system of claim 7, wherein the plural suspension units and the plural isolation mounts are attached to the sub-frame.

9. A vehicle, comprising:
an engine;
a structural assembly;
a cab mounted to the structural assembly;
a front axle coupled to the structural assembly;
plural suspension units arranged forward of the axle and disposed between the cab and the structural assembly; and
plural isolation mounts arranged rearward of the axle and disposed between the cab and the structural assembly.

10. The vehicle of claim 9, wherein the plural suspension units each comprises a coil over shock absorber.

11. The vehicle of claim 9, wherein the plural suspension units each comprises an air spring over shock absorber.

12. The vehicle of claim 9, wherein the plural suspension units each comprises two separate components, wherein one of the components comprises either a coil or air spring and the other of the components comprises a shock absorber.

13. The vehicle of claim 9, wherein each of the plural isolation mounts is comprised of rubber.

14. The vehicle of claim 9, further comprising a transverse member coupled between the structural assembly and the cab.

15. The vehicle of claim 9, wherein the structural assembly comprises a vehicle frame and a sub-frame mounted to the vehicle frame.

16. The vehicle of claim 15, wherein the plural suspension units and the plural isolation mounts are attached to the sub-frame.

17. The vehicle of claim 9, wherein the vehicle comprises a windrower, further comprising a dual path steering system coupled to the structural assembly.

18. A cab suspension method for a vehicle, the method comprising:
navigating the vehicle along a surface, the vehicle comprising a cab mounted on a structural assembly and an axle coupled to the structural assembly; and
dampening forces transmitted to the cab by dampening at a location rearward of the axle, between the structural assembly and the cab, high frequency vibrations generated by the windrower, and dampening at a location forward of the axle, between the structural assembly and the cab, primarily low frequency vibrations transmitted from the axle by virtue of the vehicle navigating the surface.

19. The method of claim 18, wherein the dampening of the high frequency vibrations is achieved using plural isolation mounts that are coupled to the structural assembly rearward of the axle.

20. The method of claim 18, wherein the dampening of the low frequency vibrations is achieved using plural suspension units that are coupled to the structural assembly forward of the axle.
